(19) United States
(12) Patent Application Publication
(10) Pub. No.: US 2005/0151066 A1
(43) Pub. Date: Jul. 14, 2005

(54) Safety device for garage door

(75) Inventor: Duke Chen, Taipei (TW)

Correspondence Address: BACON & THOMAS, PLLC, 625 SLATERS LANE, FOURTH FLOOR, ALEXANDRIA, VA, 22314, US

(73) Assignee: EQUUS Inc., Taipei (TW)

(21) Appl. No.: 10/752,693

(22) Filed: Jan. 8, 2004

(51) Int. Cl. G06M 7/00

(52) U.S. Cl. 250/221

(57) ABSTRACT

The present invention provides a safety device for garage door. It is mainly to install a light guiding mirror at each of the four corners on the inner side of a garage door. Besides, a transmitter and a receiver for laser beam and infrared beam are installed in the garage door control mechanism. Through the surrounding light guiding mirrors, the beam irradiated from the transmitter in the door control mechanism returns to the receiver as a continuous horizontal line crossing itself in a number of times. The path that the beam travels constructs an extensive sensing network. When a garage door is closing and subject to blockage, such a sensing network can respond immediately by commanding the garage door control mechanism to stop closing action and return to open state. The invention is a safety device that can improve the safety when people, cars or objects are moving in and out of a garage.

### FIELD OF THE INVENTION

The present invention is related to a safety device for garage door. More specifically, it is a safety device that is built on an extensive sensing network that can assure the safety when a garage door is closing.

The invention is mainly to install a light guiding mirror at each of the four corners on the inner side of a garage door. Besides, a transmitter and a receiver for laser beam and infrared beam are installed in the garage door control mechanism. Through the surrounding light guiding mirrors, the beam irradiated from the transmitter in the door control mechanism returns to the receiver as a continuous horizontal line crossing itself in a number of times. The path that the beam travels constructs an extensive sensing network that can prevent accidents from happening when the garage door is closing.

### BACKGROUND OF THE INVENTION

Presently, it is very popular to use automated garage door. It has a high practical value because it satisfies the car driver with safety and convenience when a car is moving in and out of a garage. Please refer to FIG. 1 for current garage door structure. On each of the two sides of a garage door (5) there is a L-shape supporting frame (50), so the garage door (5) can slide along the frame (50) through the action of the pulleys on both sides. In the center of the top, there is a fixing rod (51), which has a garage door control mechanism (52) at one end. On the fixing rod (51) there is a trolley (511) that connects to one end of a sliding rod (512), which combines with the garage door (5) at the other end. Through this structure, when the garage door (5) control mechanism (52) receives the command from a user, it automatically controls the opening and closing of a garage door (5).

To prevent the garage door (5) from hitting people when it is closing, usually there is a single-beam sensing device (53) comprising a transmitter and a receiver installed respectively nears the ground at the two sides of garage door (either cable or wireless (battery powered)). Cable device uses electric wire along the garage door (5) peripheral to connect to the door control mechanism (52), while wireless device does not need wire connection, but the batteries in the transmitter and the receiver. In a practical application when the single beam is blocked, it responds to the door control mechanism (52), which immediately reverses the motion of the garage door (5) and drives the door to an open state. In this way, the safety is assured when people, cars and objects are moving in and out of the garage.

The above-mentioned garage door safety device can effectively provide safety when the door is closing. But after careful investigation, it still has the following drawbacks that need improvement:
1. Because the traditional garage door safety device uses a single-beam sensing device, practically it only detects the obstacle in one horizontal line, but not the obstacle in other horizontal lines. A false judgment can be made in some situations, such as an obstacle positioned above or below the horizontal line beam. This can end up with an accident. It cannot assure the safety of a garage door completely. It has potential risk. It also lacks flexibility and applicability.
2. Secondly, if the transmitter and the receiver adopt cable devices, the sensing devices connect to the door control mechanism through electrical wires. This causes inconvenience for installation. Besides, the wire is easy to get damaged and needs difficult maintenance. It is also easy to get signal transmission interrupted by hardly found damaged wire. This adds extra difficulty to safety control. On the other hand, the layout and exposure of the wire affects the aesthetics of garage interior. Overly arranged wiring further creates a disorganized feeling.
3. Furthermore, if the transmitter and the receiver adopt wireless devices (battery inside), battery replacement is needed when the power is out, otherwise the sensing device will not work and bring about safety concerns for people, cars and objects.

Knowing the drawbacks of the traditional garage door safety device, the inventor of the present invention was dedicated to the development of an extensive sensing network with improved operating range and sensitivity. Especially, it provides improved safety and progressiveness. It is a garage door safety device that possesses a significant practical value and is designed to improve the above-mentioned drawbacks. Furthermore, the present invention also provides a high level of convenience and safety.

### SUMMARY OF THE INVENTION

The primary objective of the invention is to provide a garage door safety device that can significantly and extensively increase the safety of a garage door.

The second objective of the invention is to provide a garage door safety device that has simple installation without exposed wires and provides an aesthetic feeling. The device in the invention can also offer the same function as a battery-operated device can provide.

To achieve the above-mentioned objectives, the main technical approaches in the present invention is to install a light guiding mirror at each of the four corners on the inner side of a garage door. Besides, a transmitter and a receiver for laser beam and infrared beam are installed in the garage door control mechanism. Through the surrounding light guiding mirrors, the beam irradiated from the transmitter in the door control mechanism returns to the receiver as a continuous horizontal line crossing itself in a number of times. The path that the beam travels constructs an extensive sensing network. When a garage door is closing and subject to blockage, such a sensing network can respond immediately by commanding the garage door control mechanism to stop the door-closing action and return to open state. The invention is a safety device that can improve the safety when people, cars or objects are moving in and out of a garage.

Below is a description for the objectives, features and benefits of the present invention with attached figures and preferred embodiments. Through this, it is hoped the patent examiners will get a thorough understanding of the invention.

### BRIEF DESCRIPTION OF THE DRAWINGS

FIG. 1 is an illustration of the structure of a traditional garage door safety device.

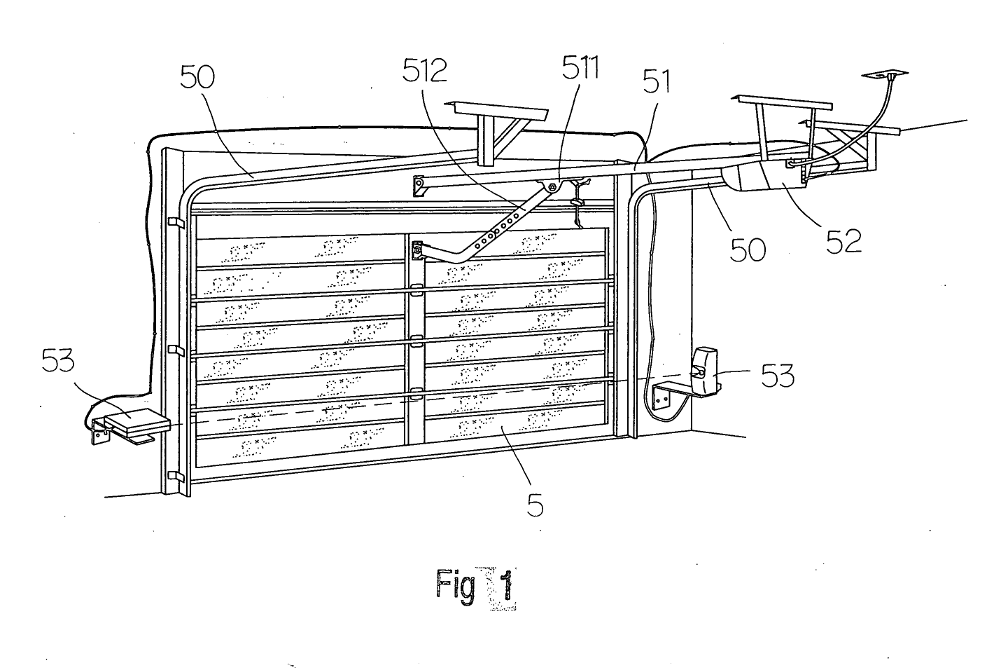

FIG. 2 is the exterior view of the entire structure of the garage door safety device for the present invention.

FIG. 3 is an illustration of the front view of the garage door safety device for the present invention.

FIG. 4 is an illustration of the top view of the garage door safety device for the present invention.

### DETAILED DESCRIPTION OF THE INVENTION

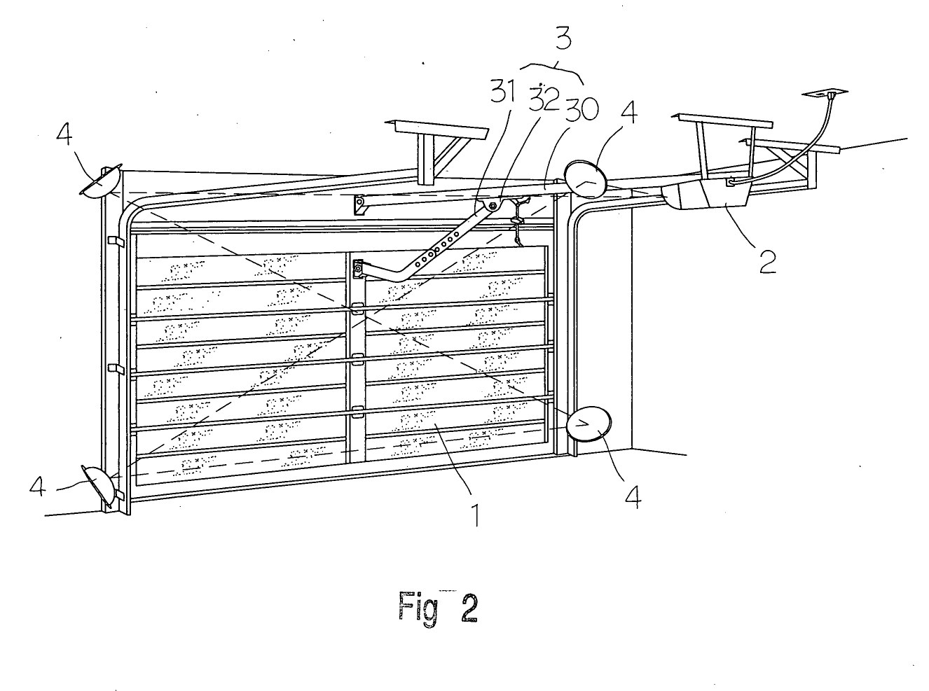

First, refer to FIG. 2 for an exterior view of the whole structure of the garage door safety device for the present invention. From the figure, it is clearly seen that the garage door (1) is similar to a common garage door in structure. It can execute the command of door-closing or door-opening right after receiving the control message. Above the garage door (1), there is a garage door control mechanism (2), which connects to the garage door (1) through a movement mechanism (3) that is composed of a fixing rod (30), a sliding rod (31) and a trolley (32). Under the command from the operator, the garage door control mechanism (2) can control the opening and closing of the garage door (1) automatically.

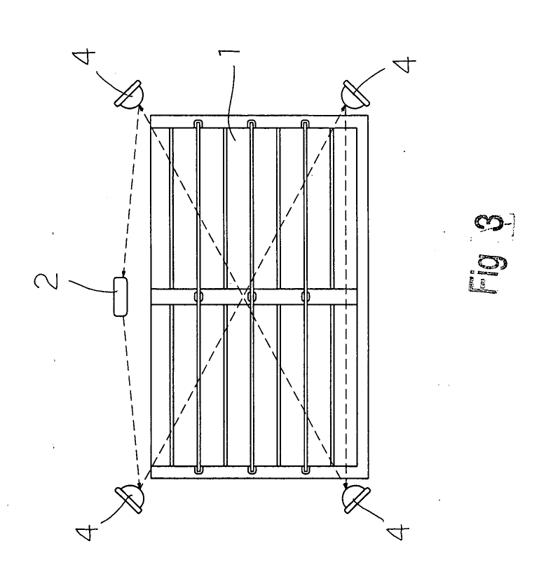

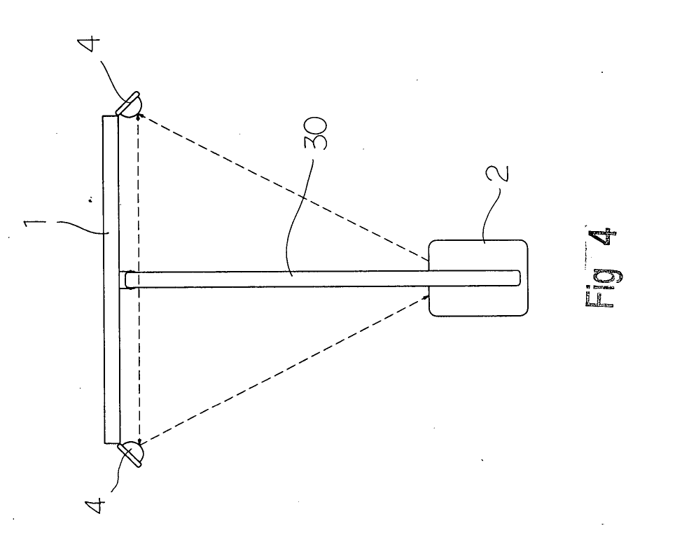

Please further refer to FIG. 3 and FIG. 4. The features of the invention include : installing a light guiding mirror (4) at each of the four corners on the inner side of the above-mentioned garage door (1); besides, installing a transmitter and a receiver for laser beam and infrared beam in the garage door control mechanism (2); and through the surrounding light guiding mirrors (4), the beam irradiated from the transmitter in the door control mechanism (2) returns to the receiver as a continuous horizontal line crossing itself in a number of times. Because of the design, the path that the beam travels constructs an extensive sensing network. When a garage door (1) is closing and subject to blockage, such a sensing network can respond (to sensing of the object) immediately by commanding the garage door (1) control mechanism (2) to stop closing action and return to open state. As a result, it effectively provides a safety measure for people, cars and objects moving in and oust of a garage.

From the above description, the present invention adds a transmitter and a receiver in the garage door control mechanism. With a number of light guiding mirrors, the invention constructs a complete and extensive sensing network. Its installation is so simple that it does not need the traditional method that puts a transmitter and a receiver under the door and needs exposed wires for connection to the door control mechanism. Especially due to the absence of exposed wires, it offers an aesthetic feeling visually. It also eliminates the unorganized feeling because there is no overly arranged wiring. In addition, the invention provides a means to prevent signal loss due to hardly found wire damage. The maintenance becomes much easier. It is unlikely for the sensing device not to operate due to negligence about replacing batteries when power is out as in the traditional wireless device. This prevents risks to the safety of people, cars and objects moving in and out of the garage.

To summarize the above description, the garage door safety device in the present invention provides a high level of safety and applicability. The extensive sensing network is considered as technical breakthrough in the field. Due to its practical value in industrial application, the invention should meet the patent requirements. A patent application is thus filed.

1. A safety device for garage door is mainly composed of a garage door, a door control mechanism on top and a movement mechanism between the door control mechanism and the garage door. It has features as follows:
a light guiding mirror installed at each of the four corners on the inner side of a garage door; a transmitter and a receiver for laser beam and infrared beam installed in the garage door control mechanism; therefore, through the surrounding light guiding mirrors, the beam irradiated from the transmitter in the door control mechanism returns to the receiver as a continuous horizontal line crossing itself in a number of times; in this way, the path that the beam travels constructs an extensive sensing network; when a garage door is closing and subject to blockage, such a sensing network can respond immediately by commanding the garage door control mechanism to stop closing action and return to open state; the invention is a safety device that can improve the safety when people, cars or objects are moving in and out of a garage.
